(19) United States
(12) Patent Application Publication
(10) Pub. No.: US 2020/0369567 A1
(43) Pub. Date: Nov. 26, 2020

(54) CEMENT COMPOSITION AND HARDENED BODY OF THE SAME

(71) Applicants: DAIO PAPER CORPORATION, Shikokuchuo-shi, Ehime (JP); SUMITOMO MITSUI CONSTRUCTION CO., LTD., Tokyo (JP)

(72) Inventors: Junya Okawa, Shikokuchuo-shi, Ehime (JP); Hiroto Sasaki, Shikokuchuo-shi, Ehime (JP); Wataru Sasaki, Tokyo (JP); Yosuke Onda, Tokyo (JP); Hideaki Taniguchi, Tokyo (JP)

(73) Assignees: DAIO PAPER CORPORATION, Shikokuchuo-shi, Ehime (JP); SUMITOMO MITSUI CONSTRUCTION CO., LTD., Tokyo (JP)

(21) Appl. No.: 16/966,275

(22) PCT Filed: Feb. 1, 2019
(86) PCT No.: PCT/JP2019/003640

§ 371 Date: Jul. 30, 2020

(30) Foreign Application Priority Data
Feb. 2, 2018 (JP) 2018-017536

(51) Int. Cl. C04B 18/24; C04B 28/04

(52) U.S. Cl. CPC C04B 18/24; B82Y 30/00; C04B 28/04

(57) ABSTRACT

A cement composition is disclosed containing: cement; cellulose nanofibers; and water, wherein a mass ratio of the water to cement is 0.4 or less. The cement is preferably Portland cement. It is preferred that the Portland cement is high-early-strength Portland cement, and that a mass ratio of fine aggregate to the high-early-strength Portland cement is 2.0 or less. A unit amount of cellulose nanofibers in the cement composition can be 0.1 kg/m³ to 15 kg/m³ Furthermore, a hardened body of the cement composition is disclosed, wherein a ratio of a splitting tensile strength of the hardened body at a material age of 91 days obtained by curing in air, to the splitting tensile strength of the hardened body at the material age if 91 days obtained by curing in water is 0.90 or more and 1.10 or less, the splitting tensile strength being measured in accordance with JIS-A-1113 (2006).

### TECHNICAL FIELD

The present invention relates to cement compositions such as cement paste, mortar, concrete, and the like, and hardened bodies thereof.

### BACKGROUND ART

Cementitious hardened bodies of concrete, mortar and the like have excellent properties of compression strength, durability, incombustibility, etc. and are inexpensive, and are therefore used in large quantities in fields of architecture and civil engineering. New construction of skyscrapers, large facilities, and the like in recent years has led to a demand for strength and durability in the cementitious hardened bodies.

To meet such demands, additives for a cement composition have been conventionally studied; for example, a technique has been proposed in which an expansion material, a drying shrinkage reducing agent, and a specific inorganic salt are added to the cement composition, thereby inhibiting cracking due to drying shrinkage and increasing durability of the cementitious hardened body (see, e.g., Japanese Unexamined Patent Application. Publication No. 2006-182619).

### PRIOR ART DOCUMENTS

### Patent Documents

Patent Document 1: Japanese Unexamined Patent Application, Publication No. 2006-182619

### SUMMARY OF THE INVENTION

### Problems to be Solved by the Invention

One cause for damage to the cementitious hardened body is cracking occurring when a tensile stress exceeding a tensile strength of the cementitious hardened body is applied to the cementitious hardened body. Therefore, to provide the cementitious hardened body with excellent durability, a cement composition that enables an increase in the tensile strength of the cementitious hardened body is needed.

The present invention was made in view of the foregoing circumstances, and an object of the present invention is to provide a cement composition that enables a hardened body in which cracking is inhibited and which has excellent durability to be obtained, and to provide a hardened body of the cement composition.

### Means for Solving the Problems

An aspect of the invention made to solve the above problems is a cement composition containing: cement; cellulose nanofibers; and water, wherein a mass ratio of the water to the cement is 0.4 or less.

One of causes for damage to a hardened body of a cement composition such as concrete or the like is cracking occurring when a tensile stress exceeding a tensile strength of the hardened body is applied to the hardened body; however, due to containing the cement and the cellulose nanofibers, and having a mass ratio of the water to the cement of 0.4 or less, i.e., a low water-cement ratio, which corresponds to a composition of high-strength concrete, the cement composition according to the present invention enables cracking to be inhibited and a hardened body having excellent durability to be obtained. Although not clarified, reasons for such effects are considered as follows.

A strength of a hardened body of a cement composition is enhanced with time. Since supply of moisture is important for a hydration reaction of the hardened body, a concrete structure is ordinarily subjected to wet curing for a certain period of time. In a case in which the wet curing is insufficient, it is natural that the strength of the hardened body of the cement composition should decrease. Thus, one cause for a decrease in a tensile strength of the hardened body of the cement composition in a dry environment is surmised as follows: when the hardened body in the middle of the hydration reaction is subjected to a dry environment, a part close to a surface of the hardened body has a lower tensile strength than that of an inside thereof. However, it is considered that when the cement composition contains the cellulose nanofibers, the hydration reaction is appropriately controlled, thereby inhibiting a decrease in the strength of the hardened body of the cement composition.

Furthermore, sodium oxide (Na₂O) and potassium oxide (K₂O) exist as alkali components in the cement, sodium hydroxide (NaOH) is generated from Na₂O when water is contained, and NaOH reacts with cellulose of the cellulose nanofibers to generate alkali cellulose in which an OH group at the sixth position of the cellulose has become a sodium salt; this is considered to be attributed to an increase in tensile strength. Moreover, setting the mass ratio of the water to the cement to 0.4 or less enhances an effect of inhibiting a decrease in splitting tensile strength in a drying process of the cement composition. In addition, since the cellulose nanofibers are a natural material, a reduction in environmental load can be expected.

“Cellulose nanofibers” as referred to herein mean fine cellulose fibers obtained by fibrillating biomass such as pulp fibers or the like, and generally means cellulose fibers containing fine cellulose fibers having a nanosized fiber width (1 nm or more and 1,000 nm or less).

The cement is preferably Portland cement. By using the Portland cement as the cement, a crack-inhibiting property and durability can be improved.

“Portland cement” as referred to herein means “Portland cement” as defined by JIS-R5210 (2009).

It is preferred that the Portland cement is high-early-strength Portland cement and that a mass ratio of fine aggregate to the high-early-strength Portland cement is 2.0 or less. One cause for damage to a hardened body of a cement composition such as concrete or the like is cracking occurring when a tensile stress exceeding a tensile strength of the hardened body is applied to the hardened body; however, when the cement composition according to the present invention contains the high-early-strength Portland cement and the cellulose nanofibers, wherein the mass ratio of the water to the high-early-strength Portland cement is 0.4 or less and the mass ratio of the fine aggregate to the high-early-strength Portland cement is 2.0 or less, a splitting tensile strength of the hardened body of the cement composition can be increased. Accordingly, a hardened body excellent in a crack-inhibiting property and durability can be obtained from the cement composition.

“High-early-strength Portland cement” as referred to herein means “high-early-strength Portland cement” categorized in accordance with JIS-R-5210 (2009) “Portland cement”.

A unit amount of the cellulose nanofibers is preferably 0.1 kg/m³ or more and 15 kg/m³ or less. When the unit amount of the cellulose nanofibers falls within the above range, an effect of inhibiting a decrease in splitting tensile strength in a drying process can be further increased without impairing properties of the hardened body of the cement composition.

Another aspect of the invention made to solve the above problems is a hardened body of the cement composition, wherein a ratio of a splitting tensile strength of the hardened body at a material age of 91 days obtained by curing in air, to the splitting tensile strength of the hardened body at the material age of 91 days obtained by curing in water is 0.90 or more and 1.10 or less, the splitting tensile strength being measured in accordance with JIS-A-1113 (2006). When the ratio of the splitting tensile strength of the hardened body of the cement composition obtained by curing in air, to the splitting tensile strength of the hardened body obtained by curing in water falls within the above range, cracking is inhibited in the hardened body of the cement composition, and the hardened body has excellent durability. In this context, “hardened body of the cement composition” according to the present invention collectively means hardened bodies of cement paste, mortar, and concrete.

It is generally surmised that a minute crack occurs first in a surface of the hardened body of the cement composition in a drying process, causing a decrease in the tensile strength in a dry environment. In a state in which cellulose molecules and water are present in the hardened body of the cement composition, hydrogen bond(s) is/are formed between the cellulose (pulp) and the water, and wetting power of the hardened body of the cement composition is weakened. Meanwhile, when the water ceases to be present as drying progresses, in a dry state, hydrogen bond(s) between cellulose molecules (pulps) and physical bond(s) between fibers enhance a network structure formed by the cellulose nanofibers, whereby the strength of the hardened body of the cement composition tends to increase. Since the cellulose nanofibers are in a fine state, this effect is considered to be further enhanced by a further increase in the number of bonding points. In other words, it is surmised that the dry environment, which is a weakness of the hardened body of the cement composition, provides an advantage in the strength of the cellulose nanofibers, and that as a result, a decrease in the tensile strength of the hardened body of the cement composition in the dry environment is inhibited.

Moreover, an unhydrated part remains in the hardened body of the cement composition. When curing in water or the like is continued, hydration proceeds in a part close to the surface of the hardened body of the cement composition; however, when drying is started in a state in which the unhydrated part remains, the hydration of the unhydrated part slows down or stops. As a result, in the dry environment, the tensile strength is low in the part close to the surface as compared with curing in water or the like, and a structure formed by the hydration of the cement is microscopically in a coarse state. It is surmised that also in such a state, an increase in the number of bonding points due to the cellulose nanofibers in a fine state further enhances the effect of inhibiting a decrease in the tensile strength of the hardened body of the cement composition in the dry environment.

As set forth above, the cellulose nanofibers contained in the hardened body of the cement composition inhibit a decrease in splitting tensile strength (strength at which cracking begins to occur) in a drying process, resulting in higher resistance to cracking. Thus, cracking is inhibited in the hardened body of the cement composition, and the hardened body has excellent durability.

### Effects of the Invention

According to the present invention, a cement composition that enables a hardened body to be obtained in which cracking is inhibited and which has excellent durability, and a hardened body thereof can be provided.

### BRIEF DESCRIPTION OF THE DRAWINGS

FIG. 1 is a graph showing a splitting tensile strength after curing in air in Examples.

FIG. 2 is a graph showing a ratio of a splitting tensile strength at each material age in a case of curing in air, to that in a case of curing in water in the Examples.

FIG. 3 is a graph showing a relation between strain and the number of days elapsed since water injection in a rebar restraining test in the Examples.

### DESCRIPTION OF EMBODIMENTS

Hereinafter, a cement composition according to an embodiment of the present invention, and a hardened body thereof will be described in detail.

Cement Composition

The cement composition contains: cement; cellulose nanofibers: and water, wherein a mass ratio of the water to the cement is 0.4 or less. The above composition of the cement composition can inhibit a decrease in splitting tensile strength in a drying process, thereby inhibiting cracking and increasing durability. It is to be noted that the cement composition can be used for cement paste, mortar, concrete, and the like.

Cement

The cement is not particularly limited, and cement produced by a known method may be used. Examples of the cement include Portland cement such as general Portland cement, high-early-strength Portland cement, ultra-high-early-strength Portland cement, moderate heat Portland cement, sulfate-resistant Portland cement, and the like; low-heat cement such as low-heat blast furnace cement, fly ash mixed low-heat blast furnace cement, belite-rich cement, and the like; a variety of types of mixed cement such as blast furnace cement, silica cement, fly ash cement, and the like; ultra-rapid hardening cement such as white Portland cement, alumina cement, magnesium phosphate cement, and the like; and hydraulic cement such as silica cement, fly ash cement, cement for grout, oil well cement, ultra-high strength cement, and the like. In addition, gypsum lime, and the like can be given as examples of air-setting cement. Of these, Portland cement is preferred. By using Portland cement as the cement, a crack-inhibiting property and durability can be improved.

Portland Cement

Furthermore, the Portland cement is not particularly limited, and Portland cement produced by a known method may be used as long as it is defined by JIS-R5210:2009. Examples of the Portland cement include general Portland cement, high-early-strength Portland cement, ultra-high-early-strength Portland cement moderate heat Portland cement, low-heat Portland cement, sulfate-resistant Portland cement, and the like.

According to knowledge of the present inventor, among a variety of types of Portland cement, it is still more preferred that high-early-strength Portland cement, which can acquire strength faster than general Portland cement, is combined with the cellulose nanofibers. The high-early-strength Portland cement is Portland cement in which a content of alite (C₃S) in a calcium silicate compound contained as a component is increased and a particle size is reduced as compared with that of the general Portland cement, whereby a hardening rate of the cement, a specific surface area, and an initial strength are increased. The cement composition containing the high-early-strength Portland cement and the cellulose nanofibers enables a hardened body excellent in a crack-inhibiting property and durability to be obtained. Although not clarified, reasons for this are surmised as follows: the high-early-strength Portland cement in which the content of the alite (C₃S) in the calcium silicate compound contained as a component of the cement is increased and the particle size is reduced as compared with that of the general Portland cement, thereby increasing the specific surface area, the initial strength, and the hardening rate of the cement, is combined with the cellulose nanofibers exhibiting a high water retention capacity, whereby an excessive hydration reaction can be controlled, and a stable initial strength and a stable hardening rate can be ensured; accordingly, a cement composition that enables a hardened body to be obtained in which cracking is inhibited and which has excellent durability can be provided.

Cellulose Nanofibers

The cellulose nanofibers (hereinafter, may be also referred to as CNF(s)) mean fibers that contain fine fibers extracted by conducting chemical and/or mechanical treatment(s) on cellulose-containing biomass such as pulp fibers. As a method for producing cellulose nanofibers, there are a method that modifies cellulose itself and a method that does not modify cellulose itself. Examples of the method that modifies cellulose itself include a method in which a part of cellulose hydroxyl groups is/are converted into carboxy group(s), phosphoric acid ester group(s), etc., and the like. Of these, the method that does not modify cellulose itself is preferred. Reasons for this can be surmised as follows, for example. The method in which a part of cellulose hydroxyl groups is/are converted into carboxy group(s), phosphoric acid ester group(s), etc. enables reducing a fiber width of the CNFs to 3 nm to 4 nm, but increases viscosity, resulting in the cement composition thickening and becoming difficult to handle, or in an inability to mix the CNFs at a predetermined additive rate. By using mechanically fibrillated CNFs, a cement composition can be obtained which has a fiber width of several tens of nanometers and can be handled, even when the CNFs are added at an additive rate at which a strength increase effect is obtained, while the cement composition is appropriately thickened. Hence, cellulose nanofibers that are not chemically modified are preferably used. Examples of the cellulose nanofibers that are not chemically modified include cellulose nanofibers obtained by refining through a mechanical treatment. An amount of converted hydroxyl groups in the cellulose nanofibers to be obtained is preferably 0.5 mmol/g or less, more preferably 0.3 mmol/g or less, and still more preferably 0.1 mmol/g or less.

Examples of the Pulp Fibers Include:

chemical pulp such as leaf kraft pulp (LKP) (e.g., leaf bleached kraft pulp (LBKP), leaf unbleached kraft pulp (LUKP), and the like), needle kraft pulp (NKP) (e.g., needle bleached kraft pulp (NBKP), needle unbleached kraft pulp (NUKP), and the like), and the like; and

mechanical pulp such as stone-ground pulp (SGP), pressure stone-ground pulp (PGW), refiner ground pulp (RGP), chemi-ground pulp (CGP), thermo-ground pulp (TGP), ground pulp (GP), thermo-mechanical pulp (TMP), chemi-thermo-mechanical pulp (CTMP), bleached thermo-mechanical pulp (BTMP), and the like.

Of these, LBKP and NBKP are preferably used because they have a low percentage content of lignin and are thus easy to refine, enabling CNFs in a range of several tens of nanometers to be easily obtained.

Before the pulp fibers in a slurry are refined by a mechanical treatment, a chemical or mechanical pretreatment may be performed in an aqueous system. The pretreatment is performed to reduce energy expended for mechanical fibrillation in a refining step performed subsequently. The pretreatment is not particularly limited as long as it is conducted by a method that does not modify a functional group of cellulose of the cellulose nanofibers and enables a reaction in an aqueous system. As described above, the cellulose nanofibers are preferably pretreated by a method that does not modify the functional group of the cellulose. Examples of the method include: a method in which as a treatment agent in the chemical pretreatment of the pulp fibers in the slurry, an N-oxyl compound which serves as a catalyst and is typified by 2,2,6,6-tetramethyl-1-piperidine-N-oxyl radical (TEMPO) is used, and a primary hydroxyl group of the cellulose is preferentially oxidized; and a method in which a hydroxyl group is modified by a phosphoric acid ester group by using a phosphoric acid-based chemical as the treatment agent: however, when the mechanical fibrillation is conducted by such a method, the pulp fibers are fibrillated rapidly, resulting in a fiber width on the order of single-digit nanometers (several nanometers), and it may be difficult to perform a refining treatment in accordance with a desired fiber size. Therefore, for example, a production method is preferred in which mechanical fibrillation is combined with a moderate chemical treatment that does not modify the cellulose hydroxyl group. Examples of the moderate chemical treatment include hydrolysis using a mineral acid (chloric acid, sulfuric acid, phosphoric acid, etc.), an enzyme, etc.; and the like. By controlling degrees of the chemical pretreatment and the mechanical fibrillation, the refining treatment can be performed in accordance with the desired fiber size. Furthermore, by performing the pretreatment in the aqueous system, cost for collecting and/or removing a solvent can be reduced. As the pretreatment, a chemical pretreatment and a mechanical pretreatment (a fibrillating treatment) may be concurrently performed in combination.

The cellulose nanofibers have one peak in a pseudo-particle size distribution curve measured in a water-dispersed state by a laser diffraction method. A particle diameter (a mode diameter) at which the pseudo-particle size distribution curve peaks is preferably 5 μm or more and 60 μm or less. The cellulose nanofibers having such a particle size distribution can be sufficiently refined and can exhibit favorable performance. It is to be noted that “pseudo-particle size distribution curve” as referred to herein means a curve indicating a volume-based particle size distribution measured using a particle size distribution meter (e.g., a laser diffraction/scattering particle size distribution analyzer available from HORIBA. Ltd.).

Average Fiber Width

An average fiber width of the cellulose nanofibers is preferably 4 nm or more and 1,000 nm or less, and more preferably 100 nm or less. Refining the fibers to the above average fiber width can greatly contribute to an increase in the strength of the hardened body of the cement composition.

The average fiber width is measured by the following method.

100 ml of an aqueous dispersion of cellulose nanofibers having a solid content concentration of 0.01% by mass or more and 0.1% by mass or less is filtered through a membrane filter made of polytetrafluoroethylene (PTFE), and the solvent is replaced with t-butanol. Next, a resultant substance is freeze-dried and coated with a metal such as osmium or the like to obtain an observation sample. The observation sample is observed using a SEM image (an observation image) thereof taken with an electron microscope at 3,000-fold, 5,000-fold, 10.000-fold, or 30,000-fold magnification in accordance with a width of constituent fibers. Specifically, two diagonal lines are drawn on the observation image, and three straight lines passing through an intersection of the diagonal lines are arbitrarily drawn. Moreover, widths of 100 fibers in total that cross these three straight lines are visually measured. Then, a median diameter of measurement values is defined as the average fiber width.

B-Type Viscosity

The lower limit of a B-type viscosity of a dispersion in a case in which the solid content concentration of the cellulose nanofibers in a solution is 1% by mass is preferably 1 cps, more preferably 3 cps, and still more preferably 5 cps. When the B-type viscosity of the dispersion is less than 1 cps, the cement composition may fail to be sufficiently thickened.

Meanwhile, the upper limit of the B-type viscosity of the dispersion is preferably 7,000 cps, more preferably 6,000 cps, and still more preferably 5,000 cps. When the B-type viscosity of the dispersion is more than 7,000 cps, pumping up of the aqueous dispersion to be transferred may require enormous energy, increasing production cost. The B-type viscosity of the aqueous dispersion of the cellulose nanofibers having a solid content concentration of 1% is measured in accordance with “Methods for viscosity measurement of liquid” as defined by JIS-Z8803 (2011). The B-type viscosity corresponds to a resistance torque at a time of stirring the slurry, and a higher B-type viscosity means that more energy is required for the stirring.

Water Retention Value

The upper limit of a water retention value of the cellulose nanofibers is preferably 600%, more preferably 580%, and still more preferably 560%. When the water retention value is more than 600%, drying efficiency may decrease, leading to an increase in production cost. The water retention value can be voluntarily controlled, for example, by selection of the pulp fibers, the pretreatment, and/or the refining treatment. The water retention value is measured in accordance with JAPAN TAPPI No. 26: 2000.

Unit Amount of Cellulose Nanofibers

Regarding a unit amount of the cellulose nanofibers in the cement composition, a unit amount with respect to mortar or cement paste is different from a unit amount with respect to concrete obtained by bonding aggregate by using cement as a matrix; the lower limit of the unit amount in the cement composition constituted by concrete, which is a main intended usage of the present invention, is preferably 0.1 kg/m³, and more preferably 0.2 kg/m³. When the unit amount is less than 0.1 kg/m³, a decrease in the splitting tensile strength of the hardened body of the cement composition in the drying process may fail to be sufficiently inhibited. Meanwhile, the upper limit of the unit amount of the cellulose nanofibers is preferably 2 kg/m³, more preferably 1.5 kg/m³, and still more preferably 1.0 kg/m³. When the unit amount is more than 2 kg/m³, the viscosity of the cement composition may become so high that there may be an effect on productivity of the cement composition, and workability relating to transportation of the cement composition, filling a formwork with the cement composition, etc. using a pump or the like. In a case of a cement composition constituted by mortar or cement paste, the unit amount of the cellulose nanofibers may be more than the unit amount with respect to the concrete; however, when the unit amount is more than 15 kg/m³, in a case of using the cellulose nanofibers in an aqueous solution, it may be difficult to control a water content in the aqueous solution to be within a unit water content in the cement composition.

Furthermore, in a case in which high-early-strength Portland cement is used as the Portland cement, due to high viscosity of the high-early-strength Portland cement, the upper limit of the unit amount of the cellulose nanofibers is preferably 1.0 kg/m³.

Fine Aggregate

In a case in which the cement composition is mortar or concrete, fine aggregate is contained therein; a type of the fine aggregate is not particularly limited. Examples of the fine aggregate include river sand, sea sand, mountain sand, quartz sand, glass sand, iron sand, ash sand, artificial sand, and the like. Furthermore, one type of these fine aggregates may be used, or two or more types may be used in combination. The aggregate refers to sand, gravel, crushed sand, crushed stones, and the like and is categorized into fine aggregate and coarse aggregate in accordance with the particle diameter. The fine aggregate is aggregate in which particles thereof totally pass through a 10 mm mesh sieve, and 85% by mass or more of particles thereof pass through a 5 mm mesh sieve.

In the case in which the cement composition is concrete, a fine aggregate percentage (a percentage s/a of the fine aggregate in the aggregate as a whole) in general concrete falls within a range of approximately 37% to 50%. The fine aggregate percentage is determined by a water-cement ratio, liquidity (slump), and the like that are needed. It is to be noted that a condition of a fine aggregate percentage of more than 50% is often set for concrete having specific functions, such as high-fluidity concrete, which enables filling without vibration compaction (self-compacting ability); short fiber-reinforced concrete, to which toughness has been added; shotcrete, which is used for forming a member by spraying; and the like. Meanwhile, the fine aggregate percentage may be set to approximately 30% in a case of (super) stiff-consistency concrete such as dam concrete, paving concrete, and the like. It is to be noted that the fine aggregate percentage (s/a) is a percentage of the fine aggregate in the aggregate as a whole.

Furthermore, in a case of using the high-early-strength Portland cement as the cement in the cement composition, a mass ratio of the fine aggregate to the high-early-strength Portland cement is preferably 2.0 or less. When the mass ratio of the fine aggregate to the high-early-strength Portland cement falls within the above range, the splitting tensile strength of the hardened body of the cement composition can be further increased.

Furthermore, mortar is a cement composition in which the fine aggregate rate is 100%. The mortar is constituted by the following basic materials: water, cement, and fine aggregate (sand). In many cases, a mass ratio of the cement to the sand is around 1:3, the mass ratio in high-strength mortar is approximately 1:2, and the mass ratio in low-strength mortar is approximately 1:4. Fundamentally, an extent to which the liquidity is to be ensured is considered, and a sand content is increased within a range in which a water content and a cement content are not excessively increased.

A coarse aggregate content decreases with an increase in the fine aggregate percentage in the concrete, and a unit water content and a unit cement content increase with a decrease in the sand content (a fine aggregate content) in the mortar; therefore, cracking is likely to occur due to an increase in shrinkage amount, and cracking is also likely to occur due to an increase in an amount of heat generation accompanying hydration of the cement. Hence, with reference to the range as above, the fine aggregate percentage in the concrete is controlled so as not to be too high, and the fine aggregate content in the mortar is controlled so as not to be too low.

Coarse Aggregate

Furthermore, in the case in which the cement composition is concrete, the cement composition further contains coarse aggregate; a type of the coarse aggregate is not particularly limited. Examples of the coarse aggregate include pebbles, gravel, crushed stones, slag, a variety of types of artificial lightweight aggregate, and the like. Furthermore, one type of these coarse aggregates may be used, or two or more types may be used in combination. The coarse aggregate is aggregate containing 85% by mass or more of particles each having a particle diameter of 5 mm or more.

Water

The upper limit of the mass ratio of the water to the cement in the cement composition is 0.4, and more preferably 0.3. When the mass ratio is more than 0.4, a decrease in the splitting tensile strength of the cement composition in the drying process may fail to be sufficiently inhibited.

Other Components

Besides the above-mentioned materials, the cement composition may contain: an air entraining agent (an AE agent) for controlling an air content; a superplasticizer for controlling slump (liquidity); a thickener; a water repellent; an expansive agent; a quick setting agent; an antilust agent; and/or the like.

By using the cement composition, a hardened body in which cracking is inhibited and which has excellent durability can be obtained. Therefore, the cement composition can be suitably used as a variety of cement compositions, particularly as cement paste, mortar, and concrete. The cement composition can also be suitably used as mobile liquids (e.g., grout and injection grout) to be injected to fill a hollow, a void, a gap, and/or the like.

Method for Preparing Cement Composition

A method for preparing the cement composition is not particularly limited, for example, the cement composition may be prepared by uniformly kneading the above materials in a mixer.

By using the cement composition, a hardened body in which cracking is inhibited and which has excellent durability can be obtained.

Hardened Body of Cement Composition

The hardened body of the cement composition (hereinafter, may be also referred to as a hardened body) is obtained using the cement composition. The hardened body may be produced by a known method; for example, a desired shape is obtained by a wet papermaking method, or an extrusion or a cast molding method. Next, the cement composition is hardened by curing in air, curing in water, steam curing, or the like; thus, the hardened body can be produced. It is to be noted that as the curing, for example, the cement composition may be poured into a formwork and then cured together with the formwork, or a formed product may be removed from the formwork and then cured.

Curing in air refers to a curing method in which a test specimen in an unconfined state is cured by being allowed to rest in a room having an average temperature of 20° C. and an average humidity of 60%.

Curing in water refers to a curing method in which in general, the formwork into which the cement composition has been poured or the hardened body is cured by immersion in water at around normal temperature. The curing in water allows a hydration reaction to progress in the hardened body, thereby stabilizing a structure of the hardened body and increasing the strength thereof.

Steam curing refers to a method in which the hardened body is cured using high-temperature steam. In a case of normal pressure steam curing, steam is applied to the hardened body under normal pressure, i.e., open-air atmospheric pressure. It is preferred that pressure is atmospheric pressure and a temperature of the steam to be used falls within a range of 40° C. to 100° C.

A ratio of a splitting tensile strength of the hardened body of the cement composition at a material age of 91 days obtained by curing in air, to the splitting tensile strength of the hardened body at the material age of 91 days obtained by curing in water is 0.90 or more and 1.10 or less, the splitting tensile strength being measured in accordance with JIS-A-1113 (2006). When the ratio of the splitting tensile strength of the hardened body obtained by curing in air, to the splitting tensile strength of the hardened body obtained by curing in water falls within the above range, the cellulose nanofibers contained in the hardened body of the cement composition inhibit a decrease in the splitting tensile strength (the strength at which cracking begins to occur) in the drying process, thereby increasing crack resistance. Thus, cracking is inhibited in the hardened body of the cement composition, and the hardened body has excellent durability.

The hardened body of the cement composition, in which cracking is inhibited and which has excellent durability, can be suitably used for a variety of applications, e.g., constructions such as skyscrapers, large facilities, and revetments; concrete structures such as containers for radioactive materials, columns, and piles; and the like.

### Other Embodiments

The present invention is not construed as being limited to the above embodiment and may be implemented in embodiments that are variously changed or modified from the above embodiment.

### EXAMPLES

Hereinafter, the present invention will be described more specifically by way of Examples; however, the following Examples should not be construed as limiting the present invention.

### Example 1

High-early-strength Portland cement, water, fine aggregate, coarse aggregate, and CNFs were mixed at their respective contents shown in Table 1 below and were kneaded to prepare a cement composition, and a fresh properties test was performed thereon as below. The cement composition was immediately placed in a formwork and subjected to curing in air or curing in water under the following conditions.

Materials Used

Cement: high-early-strength Portland cement (density: 3.13 g/cm³)
general Portland cement (density: 3.15 g/cm³)

Fine aggregate: mountain sand from Futtsu (density 2.65 g/cm³)
crushed sand from Iwase (density: 2.60 g/cm³)

Coarse aggregate: crushed stone from Iwase (density: 2.65 g/cm³)

CNFs: An aqueous dispersion of CNFs having a solid content of 2% by mass was produced by: subjecting raw material pulp (LBKP having a solid content of 2% by mass) to a pretreatment using a refiner for papermaking, and then performing a refining treatment using a high-pressure homogenizer until a pseudo-particle size distribution obtained by a particle size distribution measurement employing laser diffraction had a single peak (mode diameter: 30 μm).

Furthermore, to control slump of concrete and an air content therein, a high-performance AE water reducing agent and an AE agent, being chemical admixtures, were added.

Curing Conditions

Curing in air: a test specimen was kept in a sealed state in a test room at 20° C. until a material age of 7 days, and was thereafter allowed to rest in an unconfined state in a room having an average temperature of 20° C. and an average humidity of 60%.

Curing in water: the test specimen was immersed in water at 20° C.

### Examples 2 and Comparative Examples 1 to 4

Hardened bodies of cement compositions of Example 2 and Comparative Examples 1 to 4 were obtained in a manner similar to that of Example 1, except that types and unit amounts of raw materials were changed as shown in Table 1. It is to be noted that“−” in Table 1 below means that a corresponding component was not used.

Fresh Properties Test

As the fresh properties test, slump, an air content, and a temperature of each of the kneaded cement compositions of Examples 1 and 2 and Comparative Examples 1 to 4 were measured. The slump was measured in accordance with JIS-A-1101:2014, and the air content was measured in accordance with JIS-A-1128:2014. Furthermore, the temperature of the cement composition was measured with a thermometer. Results of the fresh properties test are shown in Table 1.

According to knowledge of the present inventors and the like, favorable fresh properties of the obtained cement composition containing the cellulose nanofibers are as follows: by setting the slump at a water-cement ratio of 0.30 to 0.40 to 10 cm to 25 cm, and the air content is set to 5% or less, a cement composition that enables a hardened body to be obtained in which cracking is inhibited and which has excellent durability, and a hardened body thereof can be provided.

TABLE 1

| | | Unit amount (kg/m³) | | | | | | | | | | | | |
|---|---|---|---|---|---|---|---|---|---|---|---|---|---|---|
| | | | | | | | | Coarse | | | | | | |
| | | Cement | | | Fine aggregate | | | aggregate | | | Fine | | | |
| | | High-early- | | | | Crushed | | Crushed | | | aggregate | Fresh properties | | |
| | Water- | strength | General | | Mountain | sand | | stone | | | percentage | | Air | Temp- |
| | cement | Portland | Portland | | sand from | from | | from | | | s/a | Slump | content | erature |
| | ratio | cement | cement | Total | Futtsu | Iwase | Total | Iwase | CNF | Water | (%) | (cm) | (%) | (C.) |
| Example 1 | 0.30 | 583.0 | | 583.0 | 281.0 | 411.0 | 692.0 | 875.0 | 0.3 | 175.0 | 44.4 | 23.0 | 33 | 25.7 |
| Example 2 | 0.40 | 438.— | — | 438.0 | 329.0 | 484.0 | 813.0 | 875.0 | 0.3 | 175.0 | 48.4 | 140 | 4.6 | 25.1 |
| Comparative | 0.30 | 583.0 | — | 583.0 | 281.0 | 411.0 | 692.0 | 875.0 | — | 175.0 | 44.4 | 22.0 | 5.4 | 25.7 |
| Example 1 | | | | | | | | | | | | | | |
| Comparative | 0.40 | 438.0 | — | 438.0 | 329.0 | 484.0 | 813.0 | 875.0 | — | 175.0 | 48.4 | 20.0 | 5.5 | 25.1 |
| Example 2 | | | | | | | | | | | | | | |
| Comparative | 0.55 | — | 336.0 | 336.0 | 352.0 | 520.0 | 872.0 | 875.0 | 0.3 | 185.0 | 50.2 | 8.5 | 5.2 | 24.3 |
| Example 3 | | | | | | | | | | | | | | |
| Comparative | 0.55 | — | 336.0 | 336.0 | 352.0 | 520.0 | 872.0 | 875.0 | — | 185.0 | 50.2 | 20.5 | 1.5 | 23.9 |
| Example 4 | | | | | | | | | | | | | | |

Evaluation

The splitting tensile strength of each of the obtained hardened bodies of the cement compositions was evaluated by the following method. Evaluation results are shown in Table 1.

Splitting Tensile Strength

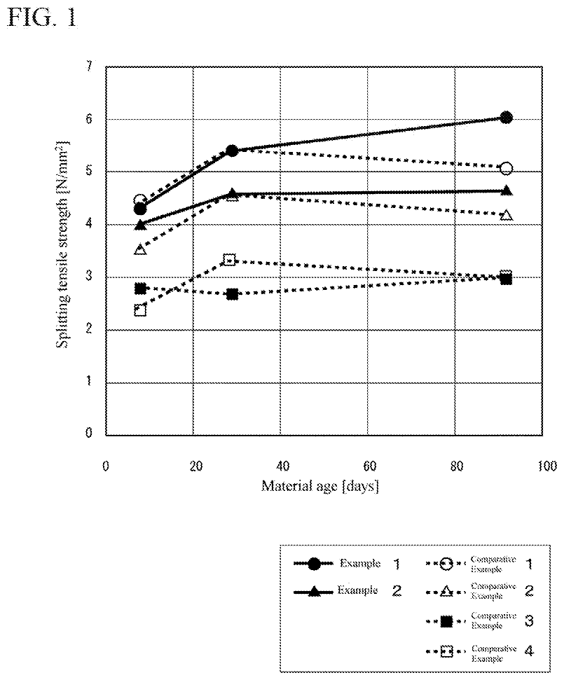

Splitting tensile strength refers to a maximum load at a time when a columnar test specimen is split by a compressive load that is applied from above and below to the test specimen laid flat, and the splitting tensile strength was measured in accordance with JIS-A-1113 (2006). The splitting tensile strength of each of the hardened bodies at material ages of 7 days, 28 days, and 91 days obtained by curing in air was measured. Results of the splitting tensile strength test are shown in FIG. 1. FIG. 1 is a graph showing the splitting tensile strength of each of the Examples and the Comparative Examples after the curing in air.

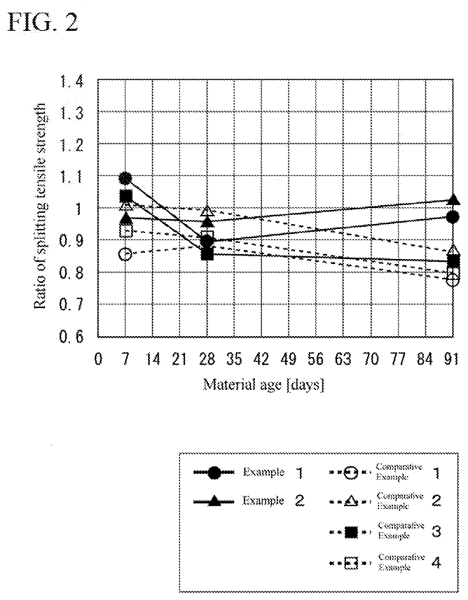

Furthermore, FIG. 2 shows measurement results of a ratio of the splitting tensile strength of the hardened body at each of the material ages obtained by curing in air, to the splitting tensile strength of the hardened body at each of the material ages obtained by curing in water in each of the Examples and the Comparative Examples. In addition, Table 2 below shows results of the ratio of the splitting tensile strength of the hardened body at the material age of 91 days obtained by curing in air, to the splitting tensile strength of the hardened body at the material age of 91 days obtained by curing in water.

Rebar Restraining Test

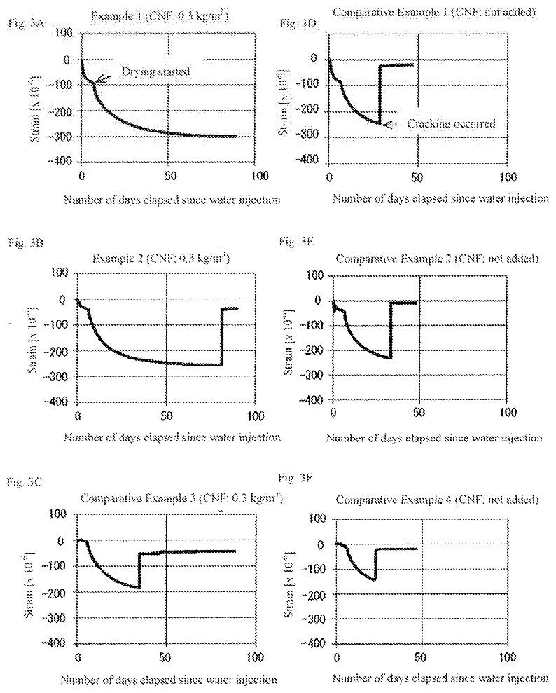

A rebar restraining test was conducted with reference to “Method for Measuring Autogenous Shrinkage Stress of Concrete,” reported by Japan Concrete Institute. Test specimens were produced in such a manner that the cement compositions of Examples 1 to 2 and Comparative Examples 1 to 3 were each placed in a formwork (100×100×1,500 mm), and rebar D32 (in a state in which joints were removed from a central 300 mm region in a length direction so as not to touch the concrete) was buried in the concrete, and restraint strain from immediately after water injection until a specific number of days elapsed was measured under the conditions of the curing in air (the test specimens were sealed until the material age of 7 days and were thereafter left at 20° C. and at an RH of 60%). Results of the rebar restraining test are shown in FIG. 3.

As shown in FIG. 1, it was found that in Example 1, which contained CNFs and had a water-cement ratio of 0.3, and Example 2, which contained CNFs and had a water-cement ratio of 0.4, the splitting tensile strength corresponding to crack occurrence strength did not decrease even at the material age of 91 days in the curing in air, and the test specimens of these Examples had excellent durability. Meanwhile, in Comparative Example 1, which contained no CNFs and had a water-cement ratio of 0.3, and Comparative Example 2, which contained no CNFs and had a water-cement ratio of 0.4, the splitting tensile strength at the material age of 91 days in the curing in air decreased. From these results, it is considered that the CNFs contained in the Examples inhibit a decrease in the splitting tensile strength in a drying process.

Furthermore, regardless of whether the CNFs were contained. Comparative Examples 3 and 4, which had a water-cement ratio of 0.55, were poor in the splitting tensile strength in the drying process, as compared with the Examples and the other Comparative Examples. Thus, it is considered that a low water-cement ratio of the cement composition, which corresponds to a composition of high-strength concrete, enables the CNFs to have an effect of inhibiting a decrease in splitting tensile strength.

Next, as shown in FIG. 2 and Table 2, in terms of the ratio of the splitting tensile strength in the Examples at each of the material ages in a case of curing in air, to that in a case of curing in water, Example 1, which contained the CNFs and had a water-cement ratio of 0.3, and Example 2, which contained the CNFs and had a water-cement ratio of 0.4, were superior to Comparative Examples 1 to 4. From these results, it is considered that the CNFs in the cement composition are strengthened at the time of drying, mitigating a decrease in splitting tensile strength due to the drying. In particular, it is considered that water-cement ratios of 0.3 and 0.4, which correspond to compositions of high-strength concrete, and addition of the CNFs enhance the effect of inhibiting a decrease in the splitting tensile strength due to the drying.

TABLE 2

| | | | Ratio of splitting tensile strength |
|---|---|---|---|
| | | | at material age of 91 days in |
| | Water-cement | CNF | case of curing in air, to that in |
| | ratio | (kg/m³) | case of curing in water |
| Example 1 | 0.30 | 0.3 | 0.97 |
| Example 2 | 0.40 | 0.3 | 1.03 |
| Comparative | 0.30 | — | 0.78 |
| Example 1 | | | |
| Comparative | 0.40 | — | 0.86 |
| Example 2 | | | |
| Comparative | 0.55 | 0.3 | 0.83 |
| Example 3 | | | |
| Comparative | 0.55 | — | 0.80 |
| Example 4 | | | |

Moreover, as shown in FIGS. 3A to 3F, when Example 1 (FIG. 3A) was compared with Comparative Example 1 (FIG. 3D), Example 2 (FIG. 3B) was compared with Comparative Example 2 (FIG. 3E), and Comparative Example 3 (FIG. 3C) was compared with Comparative Example 4 (FIG. 3F), it was confirmed that in Examples 1 and 2 and Comparative Example 3, which contained the CNFs, a time period until cracking occurred and strain rapidly decreased was longer than that in the corresponding Comparative Examples. In particular, in Example 1, which contained the CNFs and had a water-cement ratio of 0.3, no cracking was observed even after 3 months had passed since water injection. Furthermore, in Example 2, which contained the CNFs and had a water-cement ratio of 0.4, the time period until cracking occurred was longer than that in Comparative Example 3, which contained the CNFs and had a water-cement ratio of 0.5.

From these results, it is considered that the CNFs contained in the cement composition mitigate a decrease in splitting tensile strength, which corresponds to a crack occurrence strength, thereby inhibiting shrinkage cracking.

### INDUSTRIAL APPLICABILITY

By using the cement composition of the present invention, a hardened body in which cracking is inhibited and which has excellent durability can be obtained. The hardened body of the cement composition of the present invention, which has excellent durability, can be suitably used for a variety of applications, e.g., constructions such as skyscrapers, large facilities, and revetments; concrete structures such as containers for radioactive materials, columns, and piles; and the like.

1. A cement composition comprising:
cement;
cellulose nanofibers; and
water,
wherein a mass ratio of the water to the cement is 0.4 or less.

2. The cement composition according to claim 1, wherein the cement is Portland cement.

3. The cement composition according to claim 2, wherein
the Portland cement is high-early-strength Portland cement, and
a mass ratio of fine aggregate to the high-early-strength Portland cement is 2.0 or less.

4. The cement composition according to claim 1, wherein a unit amount of the cellulose nanofibers is 0.1 kg/m³ or more and 15 kg/m³ or less.

5. A hardened body of the cement composition according to claim 1, wherein a ratio of a splitting tensile strength of the hardened body at a material age of 91 days obtained by curing in air, to the splitting tensile strength of the hardened body at the material age of 91 days obtained by curing in water is 0.90 or more and 1.10 or less, the splitting tensile strength being measured in accordance with JS-A-1113 (2006).
